(19) United States
(12) Patent Application Publication
(10) Pub. No.: US 2012/0243518 A1
(43) Pub. Date: Sep. 27, 2012

(54) WIRELESS INTERNET-PROTOCOL PHONES FOR WIND POWER PLANT SERVICE

(75) Inventor: Bo Lovmand, Hadsten (DK)

(73) Assignee: VESTAS WIND SYSTEMS A/S, Randers SV (DK)

(21) Appl. No.: 13/053,648

(22) Filed: Mar. 22, 2011

(51) Int. Cl. H04W 4/00; H04W 84/12; F03D 9/00

(52) U.S. Cl. 370/338; 290/55; 370/328

(57) ABSTRACT

Communications systems and methods for a wind power plant having a plurality of wind turbines. The communications system may include a data communications network configured to provide connectivity between the wind turbines and a wireless access point coupled with the data communications network. The communications method may include wirelessly communicating signals between a mobile communications device and a wireless access point coupled with a data communications network providing connectivity between the wind turbines.

### BACKGROUND

The invention relates generally to wind power plants and, more specifically, to communications at a wind power plant.

A utility-scale wind energy system or wind power plant includes a collection of wind turbines that cooperate to produce electrical energy that may be supplied to the power grid. Often, personnel at one of the wind turbines may need to communicate with another person at the wind power plant or another person outside of the vicinity of the wind turbines. For example, during the maintenance and service of a wind power plant, service technicians may need to rely on voice contact with both site managers and other service technicians at the wind power plant, as well as voice contact with support functions distant from the wind power plant. Conventionally, service technicians may rely on walkie-talkies or mobile cellular telephones to establish voice contact. Walkie-talkies are short range communications devices and, because of that limitation, cannot be used to contact support functions distant from the wind power plant. The coverage afforded by mobile cellular telephones is often very poor at wind power plants and off-shore locations may be located outside of a coverage area.

Improved communications systems and methods are needed to facilitate effective communications at a wind power plant.

### BRIEF SUMMARY

In an embodiment of the invention, a communications system is provided for a wind power plant having wind turbines. The communications system includes a data communications network configured to provide connectivity between the wind turbines and a wireless access point coupled with the data communications network.

In another embodiment of the invention, a communications method includes wirelessly communicating signals between a mobile communications device and a wireless access point coupled with a data communications network providing connectivity between the wind turbines in a wind power plant.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a perspective view of a wind turbine.

FIG. 2 is a perspective view of a portion of the wind turbine of FIG. 1 in which the nacelle is partially broken away to expose structures housed inside the nacelle.

FIG. 3 is a diagrammatic top view of a wind power plant with a data communications network and wireless access points stationed at strategic locations of the data communications network.

FIG. 4 is a perspective view of one of the wireless access points stationed in the wind power plant of FIG. 3.

FIG. 5 is a diagrammatic view of the wireless access point of FIG. 4.

FIG. 6 is a diagrammatic view of an internet protocol (IP) telephone for use as a mobile communications device inside the wind power plant.

### DETAILED DESCRIPTION

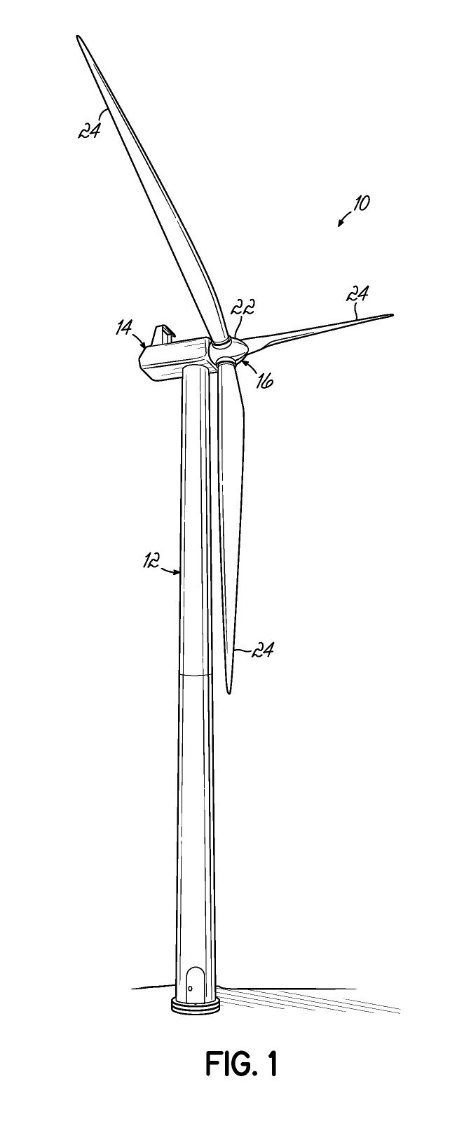

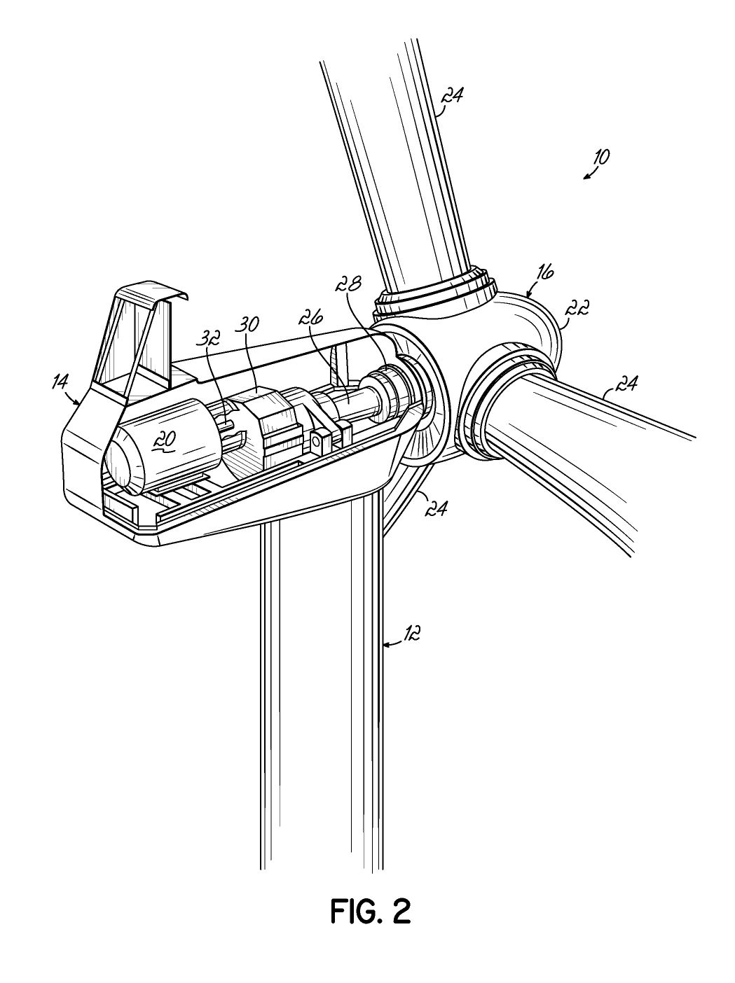

With reference to FIGS. 1 and 2 and in accordance with an embodiment of the invention, a wind turbine 10, which is depicted as a horizontal-axis machine, includes a tower 12, a nacelle 14 disposed at the apex of the tower 12, and a rotor 16 operatively coupled to a generator 20 housed inside the nacelle 14. In addition to the generator 20, the nacelle 14 houses miscellaneous components required for converting wind energy into electrical energy and various components needed to operate, control, and optimize the performance of the wind turbine 10. The tower 12 supports the load presented by the nacelle 14, the rotor 16, and other components of the wind turbine 10 that are housed inside the nacelle 14 on an underlying foundation. The tower 12 of the wind turbine 10 also operates to elevate the nacelle 14 and rotor 16 to a height above ground level or sea level, as may be the case, at which faster moving air currents of lower turbulence are typically found.

The rotor 16 includes a central hub 22 and a plurality of blades 24 attached to the central hub 22 at locations circumferentially distributed about the central hub 22. In the representative embodiment, the rotor 16 includes a plurality of three blades 24 but the number may vary. The blades 24, which project radially outward from the central hub 22, are configured to interact with the passing air currents to produce aerodynamic lift that causes the central hub 22 to spin about its longitudinal axis. The design, construction, and operation of the blades 24 are familiar to a person having ordinary skill in the art. For example, each of the blades 24 may be connected to the central hub 22 through a motorized pitch mechanism that allows the blade to pitch under control of a pitch controller (not shown). The nacelle 14 and rotor 16 may be coupled by a bearing with the tower 12 and a motorized yaw controller (not shown) may be used to maintain the rotor 16 aligned with the wind direction. These sub-system controllers may operate under the supervision of a supervisory controller (not shown) for the wind turbine 10. The controllers for the wind turbine 10 may be located inside the wind turbine 10, such as inside the tower 12 or in the nacelle 14, or outside of the wind turbine 10.

A low-speed drive shaft 26 is mechanically coupled at one end with the central hub 22 of the rotor 16 and extends into the nacelle 14. The low-speed drive shaft 26 is rotatably supported by a main bearing assembly 28 coupled to the framework of the nacelle 14. The low-speed drive shaft 26 is coupled to a gear box 30 having as an input the low-speed drive shaft 26, and having as an output a high-speed drive shaft 32 that is operatively coupled to the generator 20. Alternatively, the central hub 22 of the rotor 16 may be directly coupled with the gear box 30. The generator 20 may be any type of synchronous generator or asynchronous generator as recognized by a person having ordinary skill in the art and is generally understood to be a rotating electrical machine that converts mechanical energy into electrical energy by creating relative motion between a magnetic field and a conductor.

Wind exceeding a minimum level activates the rotor 16 and causes the blades 24 to rotate in a plane substantially perpendicular to the wind direction. The positive torque transferred from the rotor 16 to the generator 20 causes the generator 20 to convert the mechanical energy into AC electrical power so that the kinetic energy of the wind is harnessed for power generation by the wind turbine 10. The wind turbine 10 is characterized by a power curve describing the output power generated as a function of wind speed and the wind turbine 10 is operated with recognition of cut-in, rated, and cut-out wind speeds.

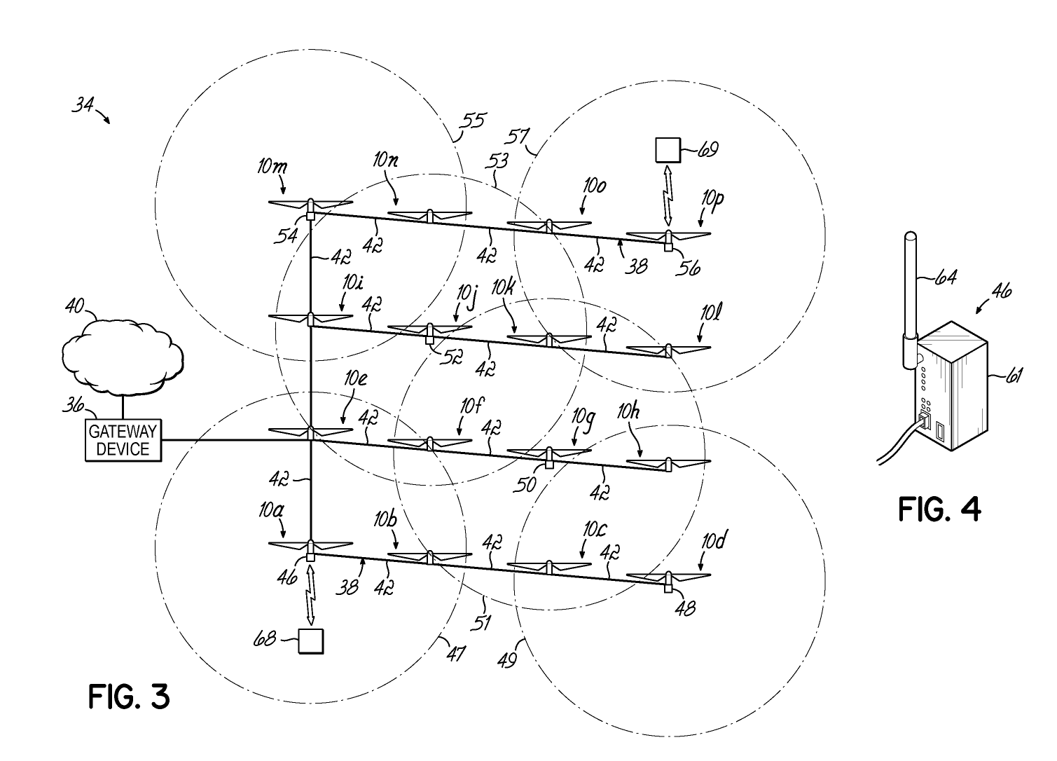

With reference to FIG. 3, a wind power plant 34 includes a representative group of wind turbines 10a-10p sited in the same area in a group onshore or offshore. Each of the wind turbines 10a-10p has a construction similar or identical to the construction of the representative wind turbine 10 (FIGS. 1, 2). In various embodiments, the wind power plant 34 may include from ten (10) to one hundred (100), or more, wind turbines distributed over tens of square kilometers of land area. The wind turbines 10a-10p are configured to constitute a unified power producing unit that is electrically coupled by transmission lines with a power grid, which may be a three-phase power grid, at a point of common coupling. While not shown in FIG. 3, devices, such as transformers, switches, energy storage, and the like, may be included as an interface between the wind turbines 10a-10p and the power grid.

The wind power plant 34 includes a data communications network, generally indicated by reference numeral 38, that provides connectivity between communication nodes at the wind turbines 10a-10p. The data communications network 38 may be a wired local area network (LAN), such as an Ethernet network using one of the IEEE 802.3 standards to provide a data link layer. The Ethernet network may rely on twisted-pair cables, or a different cable standard such as coaxial cable or optical fiber, to physically connect nodes and/or infrastructure devices (hubs, switches, routers). Internet Protocol (IP) packets of digital data may be transmitted over the data communications network 38 using a network protocol, such as Transmission Control Protocol/Internet Protocol (TCP/IP). The data communications network 38 may be partitioned into a plurality of network segments 42 in which each network segment 42 extends between a pair of the wind turbines 10a-10p and a bridge or switch may be located at each of the wind turbines 10a-10p to parse the data communications network 38 into the segments 42. The IP packets are transmitted as signals between the different segments 42 of the data communications network 38.

The data communications network 38 may be connected by a gateway device 36 with a wide area network (WAN) or public data communication network 40, e.g. the Internet. The connection between the public data communication network 40 and the data communications network 38 permits transmission of the IP packets of digital data to a location outside of the locality of the wind power plant 34. For example, a service technician at the wind power plant 34 can communicate with the site office or any support function distant from the wind turbines 10a-10p.

The gateway device 36 may include a router commonly used to join multiple networks and, in particular, to join the data communications network 38 with the public data communication network 40. The router operating as the gateway device receives IP packets, identifies the source IP address and target IP address associated with each IP packet, and forwards the IP packets as needed to ensure the encoded data reaches its intended destination.

In one embodiment, the data communications network 38 may interconnect the wind turbine controller at each of the wind turbines 10a-10p and may interconnect the wind turbine controllers with a power plant controller that exercises supervisory control over the wind turbine controllers. Control instructions may be communicated from the power plant controller to the controller at each of the wind turbines 10a-10p over the data communications network 38. The data communications network 38 may also be used to communicate monitoring data from the wind turbines 10a-10p to the power plant controller. The gateway device 36 may be located at the power plant controller.

With reference to FIGS. 3 and 4, the wind power plant 34 includes a plurality of wireless access points 46, 48, 50, 52, 54, 56 that are distributed at different physical locations among the wind turbines 10a-10p. In the representative embodiment, the wireless access points 46, 48, 50, 52, 54, 56 are located at wind turbines 10a, 10d, 10g, 10j, 10m, 10p, respectively, and are configured as industrial-type devices that are attached to a structure at the respective one of the wind turbines 10a, 10d, 10g, 10j, 10m, 10p. The wireless access points 46, 48, 50, 52, 54, 56 are configured to allow a mobile communications device 68, when within range of one or more of the wireless access points 46, 48, 50, 52, 54, 56, to wirelessly connect as a client device to the data communications network 38 and to bidirectionally communicate signals with the mobile communications device 68. Although six wireless access points 46, 48, 50, 52, 54, 56 are shown in the representative embodiment, any suitable number of wireless access points may be configured in the data communications network 38. In an embodiment, one of the wireless access points 46, 48, 50, 52, 54, 56 may be configured as a wireless router and also functionally serve as the gateway device 36.

The wireless access points 46, 48, 50, 52, 54, 56 may communicate with the mobile communication device 68 using one or more of the known 802.11 standards or communications protocols promulgated by the Institute of Electrical and Electronics Engineers (IEEE), which include, but are not limited to, 802.11a, 802.11b, 802.11e, 802.11g, and 802.11n. Each of the wireless access points 46, 48, 50, 52, 54, 56 may be directly connected by, for example, an Ethernet hub or switch with the data communications network 38. The direct connection may be established by a cable that connects a port of each of the wireless access points 46, 48, 50, 52, 54, 56 with a port at the corresponding Ethernet hub or switch.

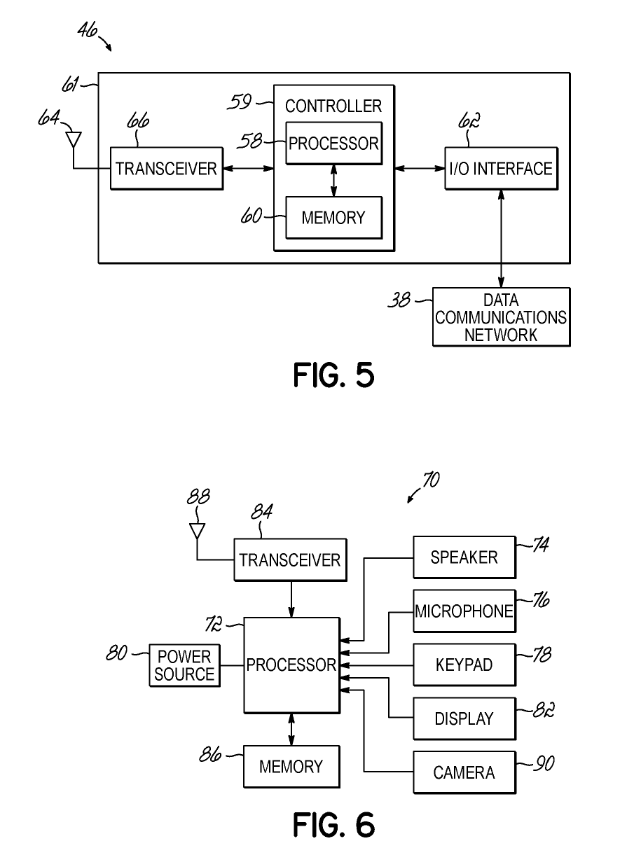

With reference to FIGS. 4 and 5, the wireless access point 46, which is representative of the wireless access points 46, 48, 50, 52, 54, 56, includes a controller 59 with processor 58 selected from microprocessors, micro-controllers, microcomputers, digital signal processors, central processing units, field programmable gate arrays, programmable logic devices, state machines, logic circuits, analog circuits, digital circuits, and/or any other devices that manipulate signals (analog and/or digital) based on operational instructions that are stored in a memory 60. The memory 60 may be a single memory device or a plurality of memory devices including, but not limited to, random access memory (RAM), volatile memory, non-volatile memory, static random access memory (SRAM), dynamic random access memory (DRAM), flash memory, cache memory, and/or any other device capable of temporarily or permanently storing digital information.

The processor 58 of the wireless access point 46 operates under the control of an operating system, and executes or otherwise relies upon computer program code embodied in various computer software applications, components, programs, objects, modules, data structures, etc. The computer program code typically comprises one or more instructions that are resident at various times in memory 60, and that, when read and executed by the processor 58, causes the wireless access point 46 to perform the steps necessary to execute steps or elements embodying the various embodiments and aspects of the invention.

The wireless access point 46 includes an input/output (I/O) interface 62 used to couple the processor 58 with the data communications network 38, an antenna 64, and a transceiver 66 coupling the antenna 64 with the processor 58. The wireless access point 46 includes an outer housing 61 that contains the controller 59, I/O interface 62, and transceiver 66. The transceiver 66 may be separated into a receiver and a transmitter separate from the receiver, and the wireless access point 46 may include more than one antenna 64. The processor 58, memory 60, I/O interface 62, and transceiver 66 are all appropriately inter-connected through suitable connections and address and data buses as would be understood by a person of ordinary skill in the art.

The transceiver 66 uses the antenna 64 to receive communications signals from the mobile communication device 68 and to send communications signals to the mobile communication device 68. The processor 58 is configured to execute program code that supervises the operation of the transceiver 66 and the I/O interface 62. The antenna 64 converts electromagnetic waves received from the mobile communications device 68 into an electrical current that is supplied to the transceiver 66 and/or converts electrical current from the transceiver 66 into electromagnetic waves transmitted to the mobile communications device 68.

Each of the wireless access points 46, 48, 50, 52, 54, 56 has a characteristic range, as diagrammatically indicated on FIG. 3 by the circles 47, 49, 51, 53, 55, 57, that establishes a maximum distance for propagating communications signals in the form of electromagnetic waves to and from the mobile communication device 68. The ranges 47, 49, 51, 53, 55, 57, which are symmetrically centered about respective wind turbines 10a, 10d, 10g, 10j, 10m, 10p in the representative embodiment, may be approximately equal, as illustrated in FIG. 3, or may differ among the different wireless access points 46, 48, 50, 52, 54, 56. The distance characterizing each of the ranges 47, 49, 51, 53, 55, 57 may depend upon multiple factors or variables, such as height above ground level or sea level, nearby obstructions and geographical topology, the operating frequency, interference from other electronic devices broadcasting on a similar frequency, the current weather, the power output, etc. The actual shape of each of the ranges 47, 49, 51, 53, 55, 57 may deviate from circularity. The layout, i.e., the spacing or separation, of the wireless access points 46, 48, 50, 52, 54, 56 may be determined by the ranges 47, 49, 51, 53, 55, 57, among other factors. Because the ranges 47, 49, 51, 53, 55, 57 may overlap, the mobile communication device 68 may sustain continuous communication with the data communications network 38 by roaming between the wireless access points 46, 48, 50, 52, 54, 56 as needed.

The mobile communication device 68 may be any type of mobile client device, such as an internet-protocol (IP) telephone or smartphone, a laptop computer containing a network interface card, a wireless network adapter, or a chipset configured for wireless communications, or any other type of mobile or portable communications device capable of wirelessly communicating with the wireless access points 46, 48, 50, 52, 54, 56. The portability of the mobile communication device 68 permits a user of device 68 to transport (e.g., carry or tote) the device 68 as the user moves from location to location within the wind power plant 34. The mobile communication device 68 is a cordless powered electrical or electronic device that is able to operate from a portable power source (e.g., a battery pack) without any cable or cord to limit the mobility of the device 68 through a continuous, wired connection to the general-purpose alternating current (AC) electric power supply (e.g., a mains power supply).

In one embodiment and with reference to FIG. 6, the mobile communication device 68 may be a portable wireless telephony device, such as a IP telephone 70 having one or more printed circuit boards that connect a processor 72, a speaker 74, a microphone 76, a keypad 78, a power source 80 such as a rechargeable lithium ion battery, a display 82 such as a liquid crystal display (LCD), a transceiver 84, a memory 86, an antenna 88, and a camera 90. The processor 72, speaker 74, microphone 76, keypad 78, power source 80, display 82, transceiver 84, memory 86, antenna 88, and camera 90 as an assembly are all appropriately inter-connected through suitable connections and address and data buses as would be understood by a person of ordinary skill in the art. The transceiver 84 may be separated into a receiver and a transmitter separate from the receiver, and the IP telephone 70 may include more than one antenna 88. The display 82 may be supplied with a touchscreen function that eliminates the necessity of the keypad 78. The IP telephone 70 is powered by the power source 80 without any cable or cord that would otherwise limit the mobility of the user of the device 68.

The processor 72 may be selected from microprocessors, micro-controllers, microcomputers, digital signal processors, central processing units, field programmable gate arrays, programmable logic devices, state machines, logic circuits, analog circuits, digital circuits, and/or any other devices that manipulate signals (analog and/or digital) based on operational instructions that are stored in the memory 86. The memory 86 may be a single memory device or plural memory devices including, but not limited to, random access memory (RAM), volatile memory, non-volatile memory, static random access memory (SRAM), dynamic random access memory (DRAM), flash memory, cache memory, and/or any other device capable of temporarily or permanently storing digital information.

The processor 72 of the IP telephone 70 operates under the control of an operating system, and executes or otherwise relies upon computer program code embodied in various computer software applications, components, programs, objects, modules, data structures, etc. The computer program code typically comprises one or more instructions that are resident at various times in memory 86, and that, when read and executed by the processor 72, causes the IP telephone 70 to perform the steps necessary to execute steps or elements embodying the various embodiments and aspects of the invention. In particular, the processor 72 controls general operations of the IP telephone 70 and data/signal transfer between the components of the assembly.

Using program code executing on the processor 72 and/or hardware, the processor 72 of the IP telephone 70 is configured to convert analog data entered using the keypad 78 and/or a touchscreen function on the display 82 (e.g., Short Message Service (SMS) text messages), analog data captured as an image by the camera 90, and analog data (e.g., a voice stream) captured by the microphone 76 into digital data and to parse the digital data into IP packets. For example, the processor 72 may include an audio codec for converting analog audio signals received as a voice stream through the microphone 76 into digital audio signals and, in addition, for converting digital audio signals into analog audio signals for output from the speaker 74. The audio codec comprises one or more digital to analog converters (DAC) and/or analog to digital converters (ADC) in order to convert digital audio signals into analogue audio signals, and vice versa. The camera 90 is configured to acquire an image and to convert the acquired image into a digital form communicated to the processor 72. The processor 72 causes the transceiver 84 to output the digital data as analog signals in the form of electromagnetic waves dispatched from the antenna 88 for receipt by one or more of the wireless access points 46, 48, 50, 52, 54, 56.

The wireless access points 46, 48, 50, 52, 54, 56 receive the electromagnetic waves from the IP telephone 70 and convert the analog data stream back into IP packets for communication or transmission over the data communications network 38 to another mobile communications device 69, such as another IP telephone similar to IP telephone 70. The mobile communication device 69 is within range of one of the wireless access points 46, 48, 50, 52, 54, 56 when linked with the IP phone 70. The IP packets may be transmitted as signals from IP phone 70 to one of the wireless access points, for example wireless access point 46, and then routed over the data communications network 38 to another of the wireless access points, for example wireless access point 56, for delivery as signals to the other mobile communication device 69. Alternatively, the IP packets can be routed over the data communications network 38 back to the same wireless access point 46 if both devices 68, 69 are in the range of the same one of the wireless access points 46, 48, 50, 52, 54, 56. The IP packets are communicated or transmitted to the mobile communication device device 69 as data signals, and received, decoded, and presented by device 69 to the service engineer or other person associated with the device 69 as a voice stream, text, an image, etc.

Using program code executing on the processor 72 and/or hardware, the processor 72 of the IP telephone 70 is configured to receive information from at least the wireless access points 46, 48, 50, 52, 54, 56 using the antenna 88 and transceiver 84. The IP telephone 70 presents the data to the service engineer or another person at the wind power plant 34 as voice from the speaker 74 and/or as text displayed on the display 82.

Alternatively, the IP packets can be transmitted over the data communications network 38 to the public data communication network 40 and then transmitted over the public data communication network 40 to a recipient or conversant not located within the ranges 47, 49, 51, 53, 55, 57. For example, the IP packets can be transmitted by the public data communication network 40 to a cellular telephone via a cell phone network. As another example, the IP packets can be transmitted by the public data communication network 40 to an analog telephone via a public switched telephone network. At the recipient (e.g., IP telephone 70), the IP packets are received, decoded, and converted to analog data to reproduce the original voice or data stream for presentation to the service engineer or another person.

The IP telephone 70 may also be a dual mode hybrid type of wireless communications device that can operate at the frequencies characteristic of IEEE 802.11 communications protocols and also at cellular frequencies using a cellular network operating under, for example, Global System for Mobile Communications (GSM) or Code Division Multiple Access (CDMA) standards. Dual mode hybrid devices can communicate with communicate with the cellular network, in addition to the communications capability with the wireless access points 46, 48, 50, 52, 54, 56.

The communication system permits service engineers or others to communicate with each other at the wind power plant 34 or to communicate outside of the range of the wireless access points 46, 48, 50, 52, 54, 56 with others regarding, for example, service, maintenance, and repair issues. The mobile communication device 68 expands coverage in remote areas, compared with the coverage exclusively afforded by cellular telephone networks. Because the mobile communication device 68 travels with the service engineer, robustness to weather and exposure to vibration, dust, extreme temperatures and seawater are not significant issues compared with fixed, non-mobile communications devices. The communications system may permit a service engineer to connect with one or more of the wireless access points 46, 48, 50, 52, 54, 56 from a boat or car at a location between different wind turbines 10a-10p.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of” or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicant's general inventive concept.

What is claimed is:

1. A communications system for a wind power plant having a plurality of wind turbines, the communications system comprising:
a data communications network configured to provide connectivity between the wind turbines of the wind power plant; and
a first wireless access point coupled with the data communications network.

2. The communications system of claim 1 further comprising:
a second wireless access point coupled with the data communications network.

3. The communications system of claim 2 wherein the first wireless access point has a first range, and the second wireless access point has a second range that overlaps with the first range of the first wireless access point.

4. The communications system of claim 2 wherein the first wireless access point is located at one of the wind turbines, and the second wireless access point is located at a different one of the wind turbines.

5. The communications system of claim 2 wherein the data communications network including a plurality of segments each extending between a different pair of the wind turbines, the first wireless access point is coupled with one of the segments of the data communications network, and the second wireless access point is coupled with a different segment of the data communications network.

6. The communications system of claim 1 further comprising:
a first mobile communications device configured to communicate with the first wireless access point.

7. The communications system of claim 6 wherein the first mobile communications device is an internet protocol phone configured to communicate signals to the first wireless access point that are transmitted by the first wireless access point as internet protocol packets of digital data over the data communications network.

8. The communications system of claim 6 further comprising:
a second mobile communications device configured to communicate with the data communications network so that the first and second mobile communications device are linked in communication.

9. The communications system of claim 8 further comprising:
a second wireless access point coupled with a different segment of the data communications network than the first wireless access point,
wherein the second mobile communications device is configured to wirelessly communicate with the second wireless access point.

10. The communications system of claim 1 wherein the data communications network is configured to be coupled in communication with a public data communication network.

11. The communications system of claim 1 wherein the first wireless access point operates in accordance with an IEEE 802.11 standard.

12. The communications system of claim 1 wherein the data communications network is a wired local area network.

13. A wind power plant coupled with a power grid, the wind turbines configured to generate power supplied to the power grid, and the wind power plant comprising the communications system of claim 1.

14. A communications method comprising:
wirelessly communicating signals between a first mobile communications device and a first wireless access point coupled with a data communications network providing connectivity between a plurality of wind turbines in a wind power plant.

15. The communications method of claim 14 further comprising:
communicating the signals from the first wireless access point data over the data communications network as internet protocol packets of digital data.

16. The communications method of claim 15 further comprising:
transmitting the internet protocol packets of digital data over the data communications network to a second mobile communications device.

17. The communications method of claim 15 further comprising:
transmitting the internet protocol packets of digital data over the data communications network to a second wireless access point; and
wirelessly communicating signals from the second wireless access point to a second mobile communications device.

18. The communications method of claim 17 wherein the first wireless access point is located at one of the wind turbines, and the second wireless access point is located at a different one of the wind turbines.

19. The communications method of claim 17 wherein the data communications network including a plurality of segments each extending between a different pair of the wind turbines, the first wireless access point is coupled with one of the segments of the data communications network, and the second wireless access point is coupled with a different segment of the data communications network.

20. The communications method of claim 14 further comprising:
transmitting the internet protocol packets of digital data over the data communications network to a public data communication network.
